(19) United States
(12) Patent Application Publication
(10) Pub. No.: US 2012/0071615 A1
(43) Pub. Date: Mar. 22, 2012

(54) Bi-Nuclear Metallocene Compound and the Preparation Method of Polyolefin Using the Same

(75) Inventors: Kyoung-Chan Lim, Daejeon (KR); Ki-Soo Lee, Daejeon (KR); Heon-Yong Kwon, Daejeon (KR); Min-Seok Cho, Daejeon (KR)

(73) Assignee: LG Chem, Ltd., Seoul (KR)

(21) Appl. No.: 13/228,905

(22) Filed: Sep. 9, 2011

(30) Foreign Application Priority Data
Sep. 14, 2010 (KR) 10-2010-0090039

(51) Int. Cl. C08F 4/76; C07F 19/00; C08F 4/6592; C07F 7/12

(52) U.S. Cl. 526/126; 556/432; 556/11; 502/152; 502/154; 502/117; 502/156

(57) ABSTRACT

The present invention relates to a binuclear metallocene compound having a new structure that is able to offer various selectivities and activities for copolymers, a preparation method thereof, and a method for preparing a polyolefin using the binuclear metallocene compound.

### TECHNICAL FIELD

The present invention relates to a binuclear metallocene compound and a method for preparing a polyolefin using the same.

### BACKGROUND ART

A ziegler-natta catalyst widely used in a commercial process is a multi-site catalyst, and thus produces polymers with a broad molecular weight distribution and an uneven comonomer distribution. Therefore, it is difficult to obtain desired physical properties.

On the contrary, a metallocene catalyst is a single-site catalyst having only a single kind of active site, and thus produces polymers with a narrow molecular weight distribution. Also, according to structures of the catalyst and ligand, molecular weight, tacticity, crystallinity, in particular, comonomer reactivity can be greatly controlled. However, a polyolefin polymerized using the metallocene catalyst has inferior workability due to a narrow molecular weight distribution, and in particular, has significantly lowered producibility when applied to some products due to the effects of extrusion load. Thus, there have been many efforts to control the molecular weight distribution of polyolefin.

To achieve this, methods of using a mononuclear metallocene compound and a binuclear metallocene compound are known.

The mononuclear metallocene compound is exemplified by U.S. Pat. No. 5,032,562, which discloses a method of preparing a polymerization catalyst by supporting two different transition metal catalysts on one support catalyst. This method is a method for synthesizing a bimodal distribution polymer by supporting a Ti-based Ziegler-Natta catalyst producing a high molecular weight polymer and a Zr-based metallocene catalyst producing a low molecular weight polymer on one support. However, this method requires a complicated and troublesome process of supporting the metallocene catalyst and causes a deterioration of the polymer morphology due to a cocatalyst.

In addition, several studies have been made to change the copolymer selectivity and activity of the catalyst upon copolymerization by using a binuclear metallocene compound. In the case of some metallocene catalysts, the copolymer incorporation and activity are reported to increase.

For example, Korean Patent Application No. 2003-12308 discloses a method of controlling the molecular weight distribution of polymers, in which the polymerization is performed while a combination of catalysts in a reactor is changed by supporting a binuclear metallocene catalyst and a mononuclear metallocene catalyst on a support together with an activating agent. However, this method is limited in simultaneous implementation of properties of the respective catalysts. In addition, this method has a drawback that a metallocene catalyst portion is departed from a supported catalyst to cause fouling in the reactor.

Further, there is a report on a preparation method of Group 4 metallocene catalysts linked by a biphenylene bridge and polymerization of ethylene and styrene using this catalyst (Organometallics, 2005, 24, 3618). According to this method, the catalyst has a higher catalytic activity and produces polymers having a higher molecular weight than the mononuclear metallocene catalyst. There is another report that the bridge structure of Group 4 binuclear metallocene catalyst is converted to change reactivity of the catalyst (Eur. Polym, J. 2007, 43, 1436).

However, these methods generate problems in the addition of substituents and the structural changes, regarding the previously reported Group 4 metallocene catalysts linked by a biphenylene bridge. Accordingly, there is a need for the development of new metallocene catalysts useful for the preparation of olefins.

### DISCLOSURE

### Technical Problem

The present invention provides a ligand compound having a new structure, which is able to offer various selectivities and activities for copolymers, a binuclear metallocene compound using the same, and a preparation method thereof.

Further, the present invention provides a method for preparing a polyolefin using the binuclear metallocene compound.

### Technical Solution

The present invention provides a compound represented by the following Chemical Formula 1:

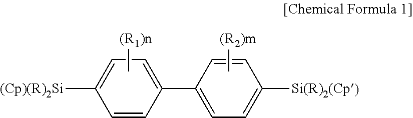

wherein Cp and Cp′ are the same as or different from each other, and each independently any one selected from the group consisting of cyclopentadienyl, indenyl, 4,5,6,7-tetrahydro-1-indenyl, and fluorenyl radicals, and they may be substituted with hydrocarbons having 1 to 20 carbon atoms;

R is the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;

R₁ and R₂ are the same as or different from each other, and each independently hydrogen, alkyl having 1 to 20 carbon atoms, or halogen; and

n and m are an integer of 1 to 4, respectively.

Further, the present invention provides a binuclear metallocene compound represented by the following Chemical Formula 5:

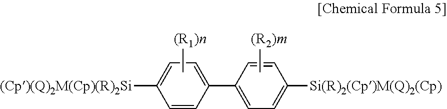

wherein Ms are the same as or different from each other, and each independently a Group 4 transition metal;

Cp and Cp′ are the same as or different from each other, and each independently any one functional group selected from the group consisting of cyclopentadienyl, indenyl, 4,5,6,7-tetrahydro-1-indenyl, and fluorenyl, and they may be substituted with hydrocarbons having 1 to 20 carbon atoms;

Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;

R₁ and R₂ are the same as or different from each other, and each independently hydrogen, alkyl having 1 to 20 carbon atoms, or halogen;

Qs are the same as or different from each other, and each independently a halogen atom; alkyl having 1 to 20 carbon atoms; alkenyl having 2 to 10 carbon atoms; alkylaryl having 7 to 40 carbon atoms; arylalkyl having 7 to 40 carbon atoms; aryl having 6 to 20 carbon atoms; substituted or unsubstituted alkylidene having 1 to 20 carbon atoms; a substituted or unsubstituted amino group; alkylalkoxy having 2 to 20 carbon atoms; or arylalkoxy having 7 to 40 carbon atoms; and

n and m are an integer of 1 to 4, respectively.

Further, the present invention provides a metallocene catalyst comprising the binuclear metallocene compound and a cocatalyst.

Further, the present invention provides a method for preparing a polyolefin, comprising the step of polymerizing at least one olefin monomer in the presence of the metallocene catalyst.

### Advantageous Effects

A binuclear metallocene compound according to the present invention is prepared by using a ligand having a novel structure that includes silicon atoms at both sides of a binuclear structure having a biphenylene group, thereby providing a binuclear metallocene catalyst capable of changing selectivity and activity for copolymers. Further, upon preparation of polyolefins, the metallocene catalyst of the present invention exhibits various activities and selectivities for copolymers while it retains advantages of other homogeneous catalysts. Furthermore, the catalyst of the present invention is able to produce high-quality polyolefins having desired physical properties at high productivity by flexibly controlling a molecular weight distribution according to a mixing ratio with a cocatalyst.

### BEST MODE

Hereinafter, the present invention will be described in detail.

The present invention provides a binuclear metallocene compound that is able to produce a polyolefin having desired properties and molecular weight distribution, and also able to more precisely control the structure of a polymer than the conventional Ziegler-Natta/metallocene hybrid catalysts and mononuclear metallocene catalysts, and a method for preparing a polyolefin using the same.

In particular, the binuclear metallocene compound of the present invention has a structure of directly linking silicon atoms at both sides of biphenylene, and thus various substituents can be introduced into the silicon atoms so as to change the structure, compared to the conventional Group 4 metallocene catalysts linked by a biphenylene bridge or mononuclear metallocene catalysts. Therefore, the binuclear metallocene compound of the present invention is able to produce polymers having different properties from those produced by the prior catalysts.

In order to provide the binuclear metallocene compound, the present invention provides a ligand compound having a novel structure.

One embodiment of the present invention provides a compound represented by the following Chemical Formula 1:

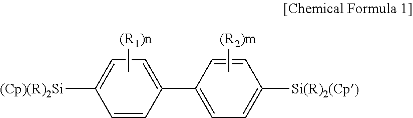

wherein Cp and Cp′ are the same as or different from each other, and each independently any one selected from the group consisting of cyclopentadienyl, indenyl, 4,5,6,7-tetrahydro-1-indenyl, and fluorenyl radicals, and they may be substituted with hydrocarbons having 1 to 20 carbon atoms;

Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;

R₁ and R₂ are the same as or different from each other, and each independently hydrogen, alkyl having 1 to 20 carbon atoms, or halogen; and

n and m are an integer of 1 to 4, respectively.

In the present invention, the compound of Chemical Formula 1 is a ligand compound having a novel structure, in which a biphenylene group as a binuclear ligand is included in its structure and silicone atoms are linked to 1, 4 positions of the biphenylene group. In addition, various substituents are introduced into the silicon atoms in the compound of Chemical Formula 1, thereby easily changing and controlling the structure and properties of the catalyst.

In the ligand compound of Chemical Formula 1, it is preferable that Cp and Cp′ are each independently cyclopentadienyl, Rs are the same as or different from each other, and each independently alkyl having 1 to 10 carbon atoms, R₁ and R₂ are the same as or different from each other, and each independently hydrogen, alkyl having 1 to 20 carbon atoms or cycloalkyl having 3 to 20 carbon atoms, and n and m are an integer of 1 to 4, respectively. More preferably, the ligand compound of Chemical Formula 1 may have a structure of the following Chemical Formula 1-1.

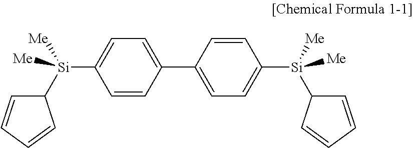

In addition, the structure of Chemical Formula 1 of the present invention may be a structure, in which substituents to be introduced at 8 positions of the biphenyl group are the same as or different from each other, and each independently a particular substituent, preferably alkyl or halogen, and the silicone atoms are substituted with an alkyl or cycloalkyl group.

In this regard, the ligand compound of Chemical Formula 1 may be prepared by reacting a compound represented by the following Chemical Formula 2 with a compound represented by the following Chemical Formula 3:

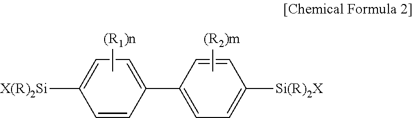

(Cp)M1 [Chemical Formula 3]

wherein Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;

X is halogen,

R₁ and R₂ are the same as or different from each other, and each independently hydrogen, alkyl having 1 to 20 carbon atoms or halogen;

Cp is the same as or different from each other, and each independently any one selected from the group consisting of cyclopentadienyl, indenyl, 4,5,6,7-tetrahydro-1-indenyl, and fluorenyl radicals, and they may be substituted with hydrocarbons having 1 to 20 carbon atoms;

M1 is an alkali metal or MgX (herein, X is a halogen atom); and

n and m are an integer of 1 to 4, respectively.

In the present invention, when the ligand compound of Chemical Formula 1 is prepared, the conditions are not particularly limited, and it may be prepared by a typical organic synthesis. For example, in the reaction, the compound of Chemical Formula 2 is added to a solvent, and the cyclopentadienyl salt compound of Chemical Formula 3 is reacted at a low temperature so as to prepare the compound of Chemical Formula 2. Preferably, the reaction is performed in the presence of a solvent at a temperature of about −100° C. to about 40° C. for about 1 hour to about 24 hours. To obtain a product after completion of the reaction, a method used in the typical organic synthesis may be employed, but is not particularly limited. In addition, the reaction solvent may be THF, DMF or the like, but is not limited thereto.

Herein, the compound of Chemical Formula 2 is used as a precursor compound of Chemical Formula 1, and it may be prepared by a typical nucleophilic reaction. For example, for the preparation of the compound of Chemical Formula 2, a halogen-containing biphenyl compound is reacted with alkyl lithium to prepare a lithium salt, followed by reaction with a silane compound at a low temperature. In this regard, the preparation of the compound of Chemical Formula 2 may be performed at a temperature of about −100° C. to about 40° C. for about 1 hour to about 24 hours.

The silane compound may be a compound represented by the following Chemical Formula a, and for example, dimethyldichlorosilane.

Si(R′)₄ [Chemical Formula a]

wherein R's are the same as or different from each other, and each independently an alkyl group having 1 to 10 carbon atoms or a halogen atom.

Meanwhile, another embodiment of the present invention provides a binuclear metallocene compound represented by the following Chemical Formula 5, which is obtained by using the ligand compound of Chemical Formula 1.

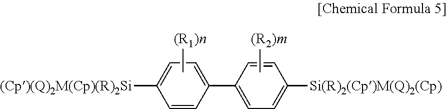

wherein Ms are the same as or different from each other, and each independently a Group 4 transition metal;

Cp and Cp′ are the same as or different from each other, and each independently any one functional group selected from the group consisting of cyclopentadienyl, indenyl, 4,5,6,7-tetrahydro-1-indenyl, and fluorenyl, and they may be substituted with hydrocarbons having 1 to 20 carbon atoms;

Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;

R₁ and R₂ are the same as or different from each other, and each independently hydrogen, alkyl having 1 to 20 carbon atoms or halogen;

Qs are the same as or different from each other, and each independently a halogen atom; alkyl having 1 to 20 carbon atoms; alkenyl having 2 to 10 carbon atoms; alkylaryl having 7 to 40 carbon atoms; arylalkyl having 7 to 40 carbon atoms; aryl having 6 to 20 carbon atoms; substituted or unsubstituted alkylidene having 1 to 20 carbon atoms; a substituted or unsubstituted amino group; alkylalkoxy having 2 to 20 carbon atoms; or arylalkoxy having 7 to 40 carbon atoms; and

n and m are an integer of 1 to 4, respectively.

As used herein, the term ‘hydrocarbyl’ means the monovalent radical obtained by removing one hydrogen atom from the parent hydrocarbon, and may include ethyl, phenyl or the like.

In Chemical Formula 5, Cp and Cp′ are each independently cyclopentadienyl, Rs are the same as or different from each other, and each independently an alkyl group having 1 to 10 carbon atoms, R₁ and R₂ are the same as or different from each other, and each independently hydrogen, alkyl having 1 to 20 carbon atoms or cycloalkyl having 3 to 20 carbon atoms, and n and m are an integer of 1 to 4, respectively.

More preferably, the binuclear metallocene compound represented by Chemical Formula 5 may be a compound represented by the following Chemical Formula 5-1.

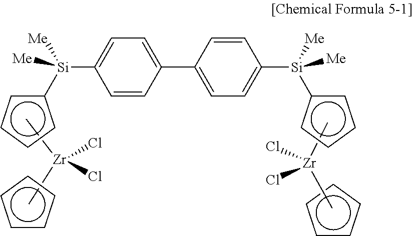

In addition, the binuclear metallocene compound of Chemical Formula 5 may be prepared using a ligand compound represented by the following Chemical Formula 1 and a metallocene compound represented by the following Chemical Formula 4:

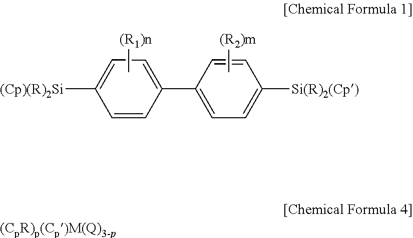

wherein Ms are the same as or different from each other, and each independently a Group 4 transition metal;

Cp and Cp′ are the same as or different from each other, and each independently any one functional group selected from the group consisting of cyclopentadienyl, indenyl, 4,5,6,7-tetrahydro-1-indenyl, and fluorenyl, and they may be substituted with hydrocarbons having 1 to 20 carbon atoms;

Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;

Qs are the same as or different from each other, and each independently a halogen atom; alkyl having 1 to 20 carbon atoms; alkenyl having 2 to 10 carbon atoms; alkylaryl having 7 to 40 carbon atoms; arylalkyl having 7 to 40 carbon atoms; aryl having 6 to 20 carbon atoms; substituted or unsubstituted alkylidene having 1 to 20 carbon atoms; a substituted or unsubstituted amino group; alkylalkoxy having 2 to 20 carbon atoms; or arylalkoxy having 7 to 40 carbon atoms;

p is 0 or 1; and

n and m are an integer of 1 to 4, respectively.

The binuclear metallocene compound according to the present invention is in a form of linking two metals to one compound, and it may be prepared by linking a compound having a cyclopentadienyl group to the ligand of the metallocene compound of Chemical Formula 1. Preferably, for the preparation of the binuclear metallocene compound of Chemical Formula 5, the compound of Chemical Formula 1 is dissolved in an organic solvent, and then reacted with alkyl lithium to prepare a lithium salt. Thereafter, the lithium salt is reacted with the metallocene compound of Chemical Formula 4 at a low temperature (e.g., about −78° C.) so as to prepare the binuclear metallocene compound of Chemical Formula 5.

A reaction molar ratio of the ligand compound represented by Chemical Formula 1 and the metallocene compound of the following Chemical Formula 4 may be about 1:1.8 to 2.2, and more preferably about 1:2. In this regard, if the reaction molar ratio is not within the above range, other compounds are produced in addition to the metallocene compound of Chemical Formula 5 or 5-1, and thus desired result cannot be obtained upon polymerization.

In this connection, the preparation of the compound of Chemical Formula 5 may be performed by a typical organic synthetic method well known to those skilled in the art, and thus the preparation conditions are not particularly limited. Preferably, the reaction may be performed at a temperature of about −100° C. to about 40° C. for about 1 hour to about 24 hours.

The binuclear metallocene compound of Chemical Formula 5 prepared by the method has a novel structure, and also has properties of easily changing the ligand structure while it retains the properties of binuclear metallocene including a biphenylene group and silicon atoms.

Further, still another embodiment of the present invention provides a metallocene catalyst that includes the binuclear metallocene compound of Chemical Formula 5 prepared by the above method and a cocatalyst.

The cocatalyst is used for activation of the binuclear metallocene compound, and may be supported on a support, together with the binuclear metallocene compound.

The cocatalyst is an organic metal compound containing a Group 13 metal. Any cocatalyst may be used, as long as it can be used for olefin polymerization in the presence of a general metallocene catalyst.

Preferably, the cocatalyst may be one or more selected from the group consisting of the compounds represented by the following Chemical Formulae 6 to 8.

—[Al(R₃)—O]c- [Chemical Formula 6]

wherein R₃s are the same as or different from each other, and each independently a halogen radical, a hydrocarbyl radical having 1 to 20 carbon atoms, or a hydrocarbyl radical having 1 to 20 carbon atoms that is substituted with halogen, and c is an integer of 2 or more,

D(R₄)₃ [Chemical Formula 7]

wherein D is aluminum or boron, and R₄ is hydrocarbyl having 1 to 20 carbon atoms or halogen-substituted hydrocarbyl having 1 to 20 carbon atoms,

[L-H]⁺[Z(E)₄]⁻ [Chemical Formula 8]

wherein L is a neutral Lewis base, [L-H]⁺ is a Bronsted acid, Z is boron or aluminum in the +3 oxidation state, and Es are each independently aryl having 6 to 20 carbon atoms or alkyl having 1 to 20 carbon atoms, in which one or more hydrogen atoms thereof are unsubstituted or substituted with halogen, hydrocarbyl having 1 to 20 carbon atoms, an alkoxy functional group, or a phenoxy functional group.

The compound represented by Chemical Formula 6 may be exemplified by methylaluminoxane (MAO), ethylaluminoxane, isobutylaluminoxane, butylaluminoxane or the like.

The alkyl metal compound represented by Chemical Formula 6 may be exemplified by trimethylaluminum, triethylaluminum, triisobutylaluminum, tripropylaluminum, tributylaluminum, dimethylchloroaluminum, dimethylisobutylaluminum, dimethylethylaluminum, diethylchloroaluminum, triisopropylaluminum, tri-s-butylaluminum, tricyclopentylaluminum, tripentylaluminum, triisopentylaluminum, trihexylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, tributylboron or the like.

The compound represented by Chemical Formula 7 may be exemplified by triethylammoniumtetraphenylboron, tributylammoniumtetraphenylboron, trimethylammoniumtetraphenylboron, tripropylammoniumtetraphenylboron, trimethylammoniumtetra(p-tolyl)boron, tripropylammoniumtetra(p-tolyl)boron, triethylammoniumtetra(o,p-dimethylphenyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenylboron, N,N-diethylaniliniumtetraphenylboron, N,N-diethylaniliniumtetrapentafluorophenylboron, diethylammoniumtetrapentafluorophenylboron, triphenylphosphoniumtetraphenylboron, trimethylphosphoniumtetraphenylboron, triethylammoniumtetraphenylaluminum, tributylammoniumtetraphenylaluminum, trimethylammoniumtetraphenylaluminum, tripropylammoniumtetraphenylaluminum, trimethylammoniumtetra(p-tolyl)aluminum, tripropylammoniumtetra(p-tolyl)aluminum, triethylammoniumtetra(o,p-dimethylphenyl)aluminum, tributylammoniumtetra(p-trifluoromethylphenyl)aluminum, trimethylammoniumtetra(p-trifluoromethylphenyl)aluminum, tributylammoniumtetrapentaf luorophenylaluminum, N,N-diethylaniliniumtetraphenylaluminum, N,N-diethylaniliniumtetraphenylaluminum, N,N-diethylaniliniumtetrapentafluorophenylaluminum, diethylammoniumtetrapentafluorophenylaluminum, triphenylphosphoniumtetraphenylaluminum, trimethylphosphoniumtetraphenylaluminum, triphenylcarboniumtetraphenylboron, triphenylcarboniumtetraphenylaluminum, triphenylcarboniumtetra(p-trifluoromethylphenyl)boron, triphenylcarboniumtetrapentafluorophenylboron or the like.

In addition, a mole ratio of the cocatalyst to the binuclear metallocene compound may be about 100 to 1,000,000 mole %. Preferably, a mole ratio of the Group 13 metal of the cocatalyst to M of the binuclear metallocene compound may be about 1:1 to 10,000, more preferably about 1:100 to 5,000, and most preferably about 1:500 to 3,000. In this regard, when the mole ratio of the Group 13 metal is less than about 1:1, the amount of the activator is relatively low, and thus the metal compound is not completely activated, and the activity of the produced catalyst compound is reduced. When the mole ratio is more than about 1:10,000, the metal compound is completely activated, but an excessive amount of the activator remains, that is, the preparation process for the catalyst composition is economically unfavorable, and the obtained polymer has poor purity.

In addition, the metallocene catalyst of the present invention may further include any one support selected from the group consisting of silica, silica-alumina, and silica-magnesia. These supports may be those dried at a high temperature, and typically contain oxides such as Na₂O, K₂CO₃, BaSO₄ and Mg(NO₃)₂, carbonates, sulfates, or nitrates.

Although a smaller amount of hydroxy groups (—OH) on the surface of the support is preferable, removal of all hydroxy groups is practically impossible. The amount of the hydroxy groups can be controlled by preparation processes and conditions or drying conditions of a support (temperature, time, and drying method, etc.). The amount of the hydroxy groups is preferably about 0.1 to 10 mmol/g, more preferably about 0.1 to 1 mmol/g, and most preferably about 0.1 to 0.5 mmol/g. To reduce side reactions by residual hydroxy groups which remain after drying, a catalyst prepared by chemically removing hydroxy groups while maintaining highly reactive siloxane groups involved in supporting may also be used.

Further, the metallocene catalyst of the present invention is prepared by supporting the cocatalyst on a support, and then supporting the binuclear metallocene compound on the support.

By this method, the binuclear metallocene compound and the cocatalyst are reacted to obtain an activated supported metallocene catalyst. If necessary, other type of metallocene compound may be further supported on the cocatalyst of the activated supported metallocene catalyst.

The metallocene catalyst of the present invention may have a catalytic activity of about 0.5×10⁻⁶ gPE/mol Cat·h to 50×10⁻⁶ gPE/mol Cat·h.

Further, still another embodiment of the present invention provides a method for preparing a polyolefin, comprising the step of polymerizing at least one olefin monomer in the presence of the metallocene catalyst using the binuclear metallocene compound.

The polymerization is accomplished by homopolymerization of single olefin monomers or by copolymerization of two or more types of monomers using a continuous slurry polymerization reactor, a loop slurry reactor, a gas phase reactor, or a solution reactor.

The olefin monomer polymerizable using the metallocene catalyst of the present invention includes ethylene, propylene, alpha olefin, and cyclic olefin, and a diene olefin monomer or a triene olefin monomer having two or more double bonds is also polymerizable.

For example, the polyolefin preparation may be performed by supplying the metallocene catalyst, and ethylene monomer and alpha olefin comonomer having 4 or more carbon atoms.

Preferably, the olefin monomer may be one or more selected from the group consisting of ethylene, propylene, 1-butene, 1-pentene, 1-hexene, 4-methyl-1-pentene, 1-octene, 1-decene, 1-dodecene, 1-tetradecene, 1-hexadecene, 1-octadecene, 1-eicosen, and mixtures thereof.

In addition, the metallocene catalyst of the present invention can be directly used for olefin polymerization. Also, it may be prepared into a pre-polymerized catalyst by contacting the metallocene catalyst with an olefin monomer such as ethylene, propylene, 1-butene, 1-hexene, and 1-octene.

In addition, when the metallocene catalyst of the present invention is used without pre-polymerization, it may be injected in a slurry form after being diluted in an appropriate aliphatic hydrocarbon solvent having 5 to 12 carbon atoms such as isobutane, pentane, hexane, heptane, nonane, decane, and isomers thereof; an aromatic hydrocarbon solvent such as toluene and benzene; or a chlorine-substituted hydrocarbon solvent such as dichloromethane and chlorobenzene. The solvent used herein may be preferably treated with a trace amount of aluminium to remove catalytic poisons such as water, air and the like.

The polyolefin polymerization is preferably performed at a temperature of about 25 to 500° C. and at about 1 to 100 kgf/cm² for about 1 to 24 hours. The reaction temperature is more preferably about 25 to 200° C., and most preferably about 50 to 100° C. In addition, the reaction pressure is more preferably about 1 to 50 kgf/cm², and most preferably about 5 to 40 kgf/cm².

The polyolefin prepared by the method may have a weight average molecular weight of about 100 to 1,000,000, and more preferably about 1,000 to 100,000. In addition, the polyolefin may have a number average molecular weight of about 100 to 20,000, and more preferably 1,000 to 20,000. Therefore, a molecular weight distribution (Mw/Mn) of the polyolefin may be about 1 to 50.

### MODE FOR INVENTION

Hereinafter, actions and effects of the present invention will be described in more detail with reference to the specific Examples. However, these examples are for illustrative purposes only and are not intended to limit the scope of the invention.

### Example 1

### Synthesis of Ligand Precursor

5 g (16 mmol) of dibromo biphenyl and a stirrer bar were put in a 250 ml flask, and 40 ml of Et₂O was added thereto, and completely dissolved. This reaction vessel was cooled to 0° C., and then 12.8 ml (32 mmol) of n-BuLi was slowly added thereto using a syringe in a drop-wise manner. After dropping, the reaction vessel was stirred at 0° C. for 2 hours or longer, and then the temperature was raised to room temperature. The reaction vessel was left at room temperature for 6 hours for further reaction. The yellow solution was removed using a cannula, and the remaining solid was washed with 20 ml of hexane three times, and then dried under vacuum so as to obtain a colorless solid. The obtained colorless solid was dissolved in 40 ml of THF, and then the temperature of the reaction vessel was reduced to −78° C. 11.6 ml (96 mmol) of dimethyldichlorosilane was rapidly added to the reaction vessel using a syringe. After stirring was performed at −78° C. for 2 hours, the reaction temperature was slowly raised to room temperature, and then stirring was performed for 15 hours. After 15 hours, all of the solvents were removed under vacuum, and 40 ml of hexane was added to extract a product. A solution was only filtered using a Cellite filter so as to obtain a clear colorless solution. This solution was left in a refrigerator (−15° C.) for several hours, so as to obtain 3.8 g of the compound of the following Chemical Formula 2 in a colorless solid form.

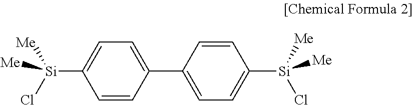

Yield=70%, colorless solid

¹H NMR (CDCl₃, 300.13 MHz, ppm): δ 7.73 (d, 2H, J=8.1 Hz, Ph), 7.65 (d, 2H, J=7.6 Hz, Ph), 0.72 (s, 12H, SiMe₂).

¹³C {¹H} NMR (CDCl₃, 75.46 MHz, ppm): δ 142.3, 135.4, 133.8, 126.9, 2.12

### Example 2

### Synthesis of Ligand

2 g (5.9 mmol) of Compound 2 and a stirrer bar were put in a 250 ml flask, and 30 ml of THF was added thereto, and dissolved. The reaction vessel was reduced to −78° C., and then 5.9 ml (11.8 mmol) of NaCp was rapidly added using a syringe. After dropping, the reaction vessel was stirred at −78° C. for 2 hours, and then the temperature was slowly raised to room temperature. Thereafter, the reaction vessel was left at room temperature for 8 hours for further reaction. Water was carefully added to the reaction vessel, and a product was extracted using Et₂O. The extracted solution was dried over MgSO₄, filtered, and then the solvent was removed under reduced pressure so as to obtain 4.7 g of the compound of the following Chemical Formula 1-1 in a light brown solid form.

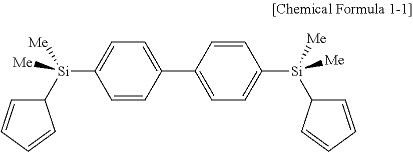

Yield=80%, light brown solid

¹H NMR (CDCl₃, 300.13 MHz, ppm): δ 7.65 (m, 8H, Ph), 6.52 (s, 8H, Cp-H), 3.63 (s, 2H, Cp-H), 0.20 (s, 12H, SiMe₂).

### Example 3

### Synthesis of Catalyst

1 g (2.5 mmol) of Compound 1-1 and a stirrer bar were put in a 250 ml flask, and 30 ml of Et₂O was added thereto, and completely dissolved. This reaction vessel was cooled to −78° C., and then 2.2 ml (5.5 mmol) of n-BuLi was slowly added thereto using a syringe in a drop-wise manner. After dropping, the reaction vessel was stirred at −78° C. for 1 hour, and then the temperature was slowly raised to room temperature. The reaction vessel was left at room temperature for 6 hours for further reaction. The solution was removed using a cannula, and the remaining solid was washed with 20 ml of hexane three times, and then dried under vacuum so as to obtain a colorless solid. 0.41 g (1 mmol) of the obtained colorless solid, 0.262 g (1 mmol) of CpZrCl₃, and a stirrer bar were put in a 250 ml flask, and the temperature of the reaction vessel was reduced to −78° C. Then, 40 ml of THF was slowly added thereto. The reaction vessel was stirred at −78° C. for 1 hour, and the temperature was slowly raised to room temperature. Thereafter, the reaction vessel was stirred at room temperature for further 15 hours. After 15 hours, the reaction mixture was filtered using a Cellite filter so as to obtain a clear brown solution. This solution was separated into two layers using Et₂O, and left in a refrigerator (−15° C.) for several days, so as to obtain 0.528 g of the compound of the following Chemical Formula 5-1 in a light brown solid form.

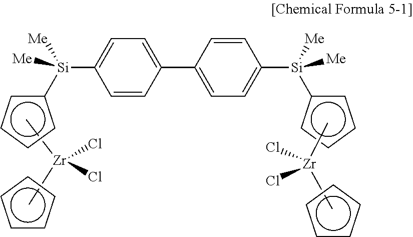

Yield=61%, brown solid

¹H NMR (CDCl₃, 300.13 MHz, ppm): δ 7.59 (s, 8H, Ph), 6.74 (m, 4H, Cp), 6.54 (m, 4H, Cp), 6.28 (m, 10H, Cp), 0.62 (s, 12H, SiMe₂).

¹³C {¹H} NMR (CDCl₃, 75.46 MHz, ppm): δ 134.6, 134.0, 126.6, 125.3, 120.1, 118.1, 116.1, 116.0, −1.742

### Examples 4 and 5

### Polymerization Using Catalyst

In order to examine catalytic activity of the synthesized binuclear compound 5-1 and its effects according to polymerization conditions, ethylene polymerization and ethylene/1-octene copolymerization were performed under various polymerization temperatures (50, 70, 90° C.) and at various ratios of Al/Zr (500, 1000, 2000).

The ethylene polymerization was performed for 15 minutes (Example 4), and ethylene/1-octene copolymerization was performed for 40 minutes (Example 5).

5 μmol of the catalyst was used, and ethylene polymerization was performed at a pressure of 1 atm, and 50 ml of toluene was used as a polymerization solvent. That is, 250 ml flask containing a stirrer bar, MAO and toluene was placed in a water bath or oil bath that was heated to a polymerization temperature. A polymerization vessel was filled with 1 atm of ethylene under stirring. Thereafter, the ethylene polymerization was started by adding the catalyst using a syringe.

For the ethylene/1-octene copolymerization, 45 ml of toluene was used together with 10 ml of 1-octene as a polymerization solvent. After the predetermined polymerization time, the supply of ethylene gas was stopped, and a small amount of 10% HCl/methanol solvent was added to the polymerization vessel so as to terminate the polymerization. Then, an excessive amount of methanol was added to precipitate a polymer. The obtained polymer was filtered using a filter, and washed with an excessive amount of methanol three or four times. The polymer was dried in a 40° C. vacuum oven for 12 hours so as to obtain a desired polymer.

Subsequently, physical properties of the obtained polymer of Example 4 were measured under each condition, and the results are shown in Table 1 (Experimental conditions: [Cat]=5 μmol, toluene=50 mL, pressure=1 bar, time=15 minutes).

In addition, the physical properties of the obtained polymer of Example 5 were measured under each condition, and the results are shown in Table 2 (Experimental conditions: [Cat]=5 μmol, toluene+1-octene=55 mL (1-octene=10 mL), Pressure=1 bar, Time=40 minutes).

The molecular weight and molecular weight distribution were analyzed by GPC (gel permeation chromatography) using a Waters 150CV+ instrument. The analysis was performed at a temperature of 140° C., and trichlorobenzene was used as a solvent, and a number average molecular weight (Mₙ) and a weight average molecular weight (M_{w}) were determined as polystyrene standard. The molecular weight distribution (Polydispersity index, PDI) was calculated by dividing the weight average molecular weight by the number average molecular weight.

### Comparative Example 1

Polymerization was performed using a [TMSCp]₂ZrCl₂ catalyst having a similar structure under the same conditions as in Example 4, except [MAO]/[Cat]=600/1 and the reaction temperature of 90° C. The results are shown in Table 1.

TABLE 1

| | | | | Activity | | | |
|---|---|---|---|---|---|---|---|
| | | | | (×10⁻⁶ gPE/mol | | | |
| | [MAO]/[Cat] | Tₚ (° C.) | Yield (g) | Cat h) | Mn | Mw | PDI |
| 1 | 500 | 50 | 1.19 | 0.95 | 147000 | 651200 | 4.43 |
| 2 | 1000 | | 1.24 | 0.99 | 16200 | 83800 | 5.17 |
| 3 | 2000 | | 1.57 | 1.25 | 6100 | 42300 | 6.93 |
| 4 | 500 | 70 | 3.40 | 2.72 | 20400 | 145500 | 5.62 |
| 5 | 1000 | | 4.93 | 3.94 | 14500 | 118400 | 8.17 |
| 6 | 2000 | | 3.61 | 2.89 | 6300 | 19000 | 3.02 |
| 7 | 500 | 90 | 2.51 | 2.01 | 17600 | 163800 | 9.31 |
| 8 | 1000 | | 2.72 | 2.17 | 17700 | 65600 | 3.71 |
| 9 | 2000 | | 3.13 | 2.51 | 7100 | 21900 | 3.08 |
| Comparative | 600 | 90 | 1.25 | 1.00 | 16,200 | 51,200 | 3.16 |
| Example 1 | | | | | | | |

TABLE 2

| | | | | | | | |
|---|---|---|---|---|---|---|---|
| | | | | Activity | | | |
| | | | [Oct] | (×10⁻⁶ gPE/mol | | | |
| [MAO]/[Cat] | Tₚ (° C.) | Yield (g) | (mol %) | Cat h) | Mn | Mw | PDI |

| | | | | | | | | |
|---|---|---|---|---|---|---|---|---|
| 1 | 500 | 50 | 10.1 | 42.1 | 3.03 | 1800 | 6400 | 3.56 |
| 2 | 1000 | | 10.3 | 36.7 | 3.10 | 1000 | 3600 | 3.6 |
| 3 | 2000 | | 11.2 | 54.8 | 3.35 | 800 | 1700 | 2.13 |
| 4 | 500 | 70 | 10.2 | 31.5 | 3.07 | 1100 | 3300 | 3.0 |
| 5 | 1000 | | 11.7 | 36.7 | 3.52 | 900 | 2900 | 3.22 |
| 6 | 2000 | | 11.2 | 34.2 | 3.35 | 1200 | 3500 | 2.92 |
| 7 | 500 | 90 | 7.93 | 35.1 | 2.38 | 4600 | 27000 | 5.87 |
| 8 | 1000 | | 8.25 | 36.7 | 2.48 | 700 | 1700 | 2.43 |
| 9 | 2000 | | 8.65 | 36.4 | 2.59 | 800 | 1900 | 2.38 |

As shown in Tables 1 and 2, when the metallocene catalyst having a novel structure of ligand containing silicon atoms at both sides of a binuclear structure having a biphenylene group was used in the present invention, the selectivity and activity for copolymers can be changed. In addition, a molecular weight distribution can be easily controlled by changing a mixing ratio of the catalyst of the present invention and a cocatalyst, thereby producing high-quality polyolefins having desired physical properties at high productivity.

1. A compound represented by the following Chemical Formula 1: 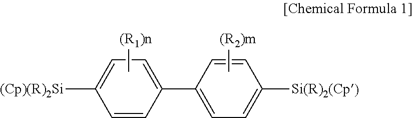
wherein Cp and Cp′ are the same as or different from each other, and each independently any one selected from the group consisting of cyclopentadienyl, indenyl, 4,5,6,7-tetrahydro-1-indenyl, and fluorenyl radicals, and they are substituted with hydrocarbons having 1 to 20 carbon atoms;
Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;
R₁ and R₂ are the same as or different from each other, and each independently hydrogen, alkyl having 1 to 20 carbon atoms, or halogen; and
n and m are an integer of 1 to 4, respectively.

2. The compound according to claim 1, wherein in Chemical Formula 1, Cp and Cp′ are each independently cyclopentadienyl, Rs are the same as or different from each other, and each independently alkyl having 1 to 10 carbon atoms, R₁ and R₂ are the same as or different from each other, and each independently hydrogen, alkyl having 1 to 20 carbon atoms or cycloalkyl having 3 to 20 carbon atoms, and n and m are an integer of 1 to 4, respectively.

3. The compound according to claim 1, wherein the metallocene compound is represented by the following Chemical Formula 1-1:

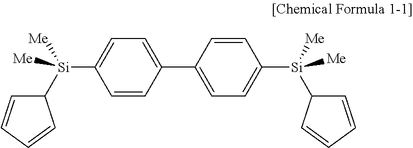

4. A binuclear metallocene compound represented by Chemical Formula 5: 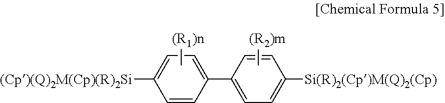
wherein Ms are the same as or different from each other, and each independently a Group 4 transition metal;
Cp and Cp′ are the same as or different from each other, and each independently any one functional group selected from the group consisting of cyclopentadienyl, indenyl, 4,5,6,7-tetrahydro-1-indenyl, and fluorenyl, and they are substituted with hydrocarbons having 1 to 20 carbon atoms;
Rs are the same as or different from each other, and each independently hydrogen, alkyl having 1 to 20 carbon atoms, cycloalkyl having 3 to 20 carbon atoms, alkoxy having 1 to 10 carbon atoms, aryl having 6 to 20 carbon atoms, aryloxy having 6 to 10 carbon atoms, alkenyl having 2 to 20 carbon atoms, alkylaryl having 7 to 40 carbon atoms, arylalkyl having 7 to 40 carbon atoms; arylalkenyl having 8 to 40 carbon atoms; or alkynyl having 2 to 10 carbon atoms;
R₁ and R₂ are the same as or different from each other, and each independently hydrogen, alkyl having 1 to 20 carbon atoms or halogen;
Qs are the same as or different from each other, and each independently a halogen atom; alkyl having 1 to 20 carbon atoms; alkenyl having 2 to 10 carbon atoms;
alkylaryl having 7 to 40 carbon atoms; arylalkyl having 7 to 40 carbon atoms; aryl having 6 to 20 carbon atoms; substituted or unsubstituted alkylidene having 1 to 20 carbon atoms; a substituted or unsubstituted amino group; alkylalkoxy having 2 to 20 carbon atoms; or arylalkoxy having 7 to 40 carbon atoms; and
n and m are an integer of 1 to 4, respectively.

5. The binuclear metallocene compound according to claim 4, wherein in Chemical Formula 5, Cp and Cp′ are each independently cyclopentadienyl, Rs are the same as or different from each other, and each independently alkyl having 1 to 10 carbon atoms, R₁ and R₂ are the same as or different from each other, and each independently hydrogen, alkyl having 1 to 20 carbon atoms or cycloalkyl having 3 to 20 carbon atoms, and n and m are an integer of 1 to 4, respectively.

6. The binuclear metallocene compound according to claim 4, wherein the compound represented by Chemical Formula 5 is represented by the following Chemical Formula 5-1:

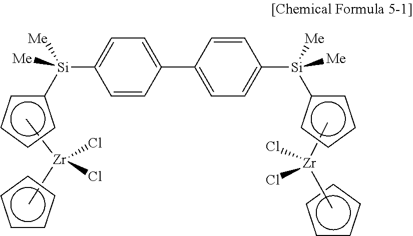

7. A metallocene catalyst, comprising the binuclear metallocene compound according to any one of claims 4 to 6 and a cocatalyst.

8. The metallocene catalyst according to claim 7, further comprising any one support selected from the group consisting of silica, silica-alumina, and silica-magnesia

9. The metallocene catalyst according to claim 7, wherein the cocatalyst includes a Group 13 metal, and a mole ratio of the Group 13 metal to M of the binuclear metallocene compound is 1:1 to 10,000.

10. The metallocene catalyst according to claim 7, wherein the cocatalyst is any one or more selected from the group consisting of compounds represented by the following Chemical Formulae 6 to 8:
—[Al(R₃)—O]c- [Chemical Formula 6]
wherein R₃s are the same as or different from each other, and each independently a halogen radical, a hydrocarbyl radical having 1 to 20 carbon atoms, or a hydrocarbyl radical having 1 to 20 carbon atoms that is substituted with halogen, and c is an integer of 2 or more,
D(R₄)₃ [Chemical Formula 7]
wherein D is aluminum or boron, and R₄ is hydrocarbyl having 1 to 20 carbon atoms or halogen-substituted hydrocarbyl having 1 to 20 carbon atoms,
[L-H]⁺[Z(E)₄]⁻ [Chemical Formula 8]
wherein L is a neutral Lewis base, [L-H]+ is a Bronsted acid, Z is boron or aluminum in the +3 oxidation state, and E is each independently aryl having 6 to 20 carbon atoms or alkyl having 1 to 20 carbon atoms, in which one or more hydrogen atoms thereof are unsubstituted or substituted with halogen, hydrocarbyl having 1 to 20 carbon atoms, an alkoxy functional group, or a phenoxy functional group.

11. A method for preparing a polyolefin, comprising the step of polymerizing one or more olefin monomers in the presence of the metallocene catalyst according to any one of claims 7 to 10.

12. The method according to claim 11, wherein the polyolefin polymerization is performed at a temperature of 25 to 500° C. and at 1 to 100 kgf/cm² for 1 to 24 hours.

13. The method according to claim 11, wherein the olefin monomer is one or more selected from the group consisting of ethylene, 1-butene, 1-pentene, 1-hexene, 4-methyl-1-pentene, 1-octene, 1-decene, 1-dodecene, 1-tetradecene, 1-hexadecene, 1-octadecene, 1-eicosen, and mixtures thereof.

14. The method according to claim 11, wherein the polyolefin has a molecular weight distribution (Mw/Mn) of 1 to 50.
